(19) United States
(12) Patent Application Publication
(10) Pub. No.: US 2014/0248931 A1
(43) Pub. Date: Sep. 4, 2014

(54) Method for Playing a Game

(71) Applicant: Yansen Halim, Singapore (SG)

(72) Inventor: Yansen Halim, Singapore (SG)

(73) Assignee: GALAXY CITY HOLDINGS LIMITED, Singapore (SG)

(21) Appl. No.: 14/350,458

(22) PCT Filed: Jul. 27, 2012
(86) PCT No.: PCT/SG2012/000273

§ 371 Date: Apr. 15, 2014

(30) Foreign Application Priority Data
Oct. 31, 2011 (SG) 201107982-9

(51) Int. Cl. A63F 9/20; A63F 13/30

(52) U.S. Cl. CPC A63F 9/20; A63F 13/12
USPC 463/11; 273/293

(57) ABSTRACT

The present invention relates to a new game. In particular, in a preferred embodiment, the present invention relates to a new game using the tiles played in the Chinese game of Mahjong. The method comprising: providing a deck of playing tiles, each tile having a character printed on it; determining the number of tiles as an initial hand for each player, the number of tiles comprising 4, 7, 10 or 13 tiles; providing each player with the initial hand of tiles; during a turn for a player, requiring the player to draw 1 tile from the deck, & playing the game until a player forms a winning hand, wherein the winning hand comprises 2 identical tiles, and the remaining tiles forming sets of 3 tiles selected from the group comprising: a set of 3 identical tiles or a set of 3 sequential tiles in a suit. A method for operating an online gaming environment for conducting the game is disclosed.

### FIELD OF INVENTION

The present invention relates to a new game. In particular, in a preferred embodiment, the present invention relates to a new game using the tiles played in the Chinese game of Mahjong. The game may also be played at a table in different venues including but not limited to home, schools, casinos and other venues and also virtual tables through the internet including social network platforms that may be accessed via the internet or other communication networks with third parties. The game is of both entertainment and educational value. In addition, the game may also be played in variety of ways, on information storage devices including but not limited to the CDs (C-ROMs), video compact disc (video discs), interactive CDs (CD-Is), on stand-alone machines similar to slot machines and on wireless devices including but not limited to mobile phones. The present invention relates to a method for playing the game and also a method for operating an online gaming environment for conducting the game through various communications media available in the market.

### BACKGROUND

Mahjong is a Chinese game that is typically played by four players against one another. There are many variations of the game but, in a typical example, a Mahjong game set comprises of tiles—of which there are 34 different types. These tiles are grouped into suits and are the four Winds (East, South, West and North), the three Dragons (Green, Red and White), the Bamboo tiles (numbered in sequence from one to nine), the Circle tiles (numbered in sequence from one to nine), and the Wan tiles (numbered in sequence from one to nine). For each of the 34 different tile types there are four identical pieces provided in the Mahjong game set. The total number of playing tiles in the game is therefore 136 tiles. However, in a set, there may also be included eight special tiles that are used solely for the purpose of scoring bonus points. These special tiles include the Flower and Season suits. This brings a total of 144 tiles in a typical Mahjong game set.

There are various methods of playing the Mahjong game, in particular there are regional variations of the rules in Asia. In most variations, each player begins by receiving thirteen tiles. In turn, each player takes a turn picking up a tile from a central pool of tiles and then discarding a tile by throwing it onto a discard pile that is usually in the centre of the table. During play, the number of tiles maintained by each player should always be thirteen tiles (meaning in each turn a tile must be picked up and another discarded). If a player is seen to have more or less than thirteen tiles in their hand outside of their turn they are penalised.

Play continues this way until one player has a winning hand. A winning hand is formed by using the fourteenth drawn tile to form four groups and a pair of identical tiles. The winning hand may be formed either from a tile drawn from the central pool of tiles, or by using a tile that has been discarded by a player. There are fairly standard rules about how a tile is drawn or stolen from another player, the order of dealing and playing.

While the basic game-play is more or less the same throughout Mahjong, the greatest divergence between variations lies in the scoring systems. Like the game play, there is a generalized system of scoring but the scoring system is complex and involves the players obtaining points for their hand of tiles, and then paying each other based on the differences in their score and who obtained the winning hand. The points are given a monetary value agreed by the players. Because of the large differences between the various systems of scoring, groups of players will often need to agree on particular scoring rules before a game, in order to eliminate possible disputes during the game. Like with game play, many attempts have been made to create an international standard of scoring, but most are not widely accepted. The players can only claim their winnings at the end of the game.

Hence, due to the variations and complex winning and scoring systems, the current method of playing Mahjong is both complicated and time-consuming.

### SUMMARY OF INVENTION

In accordance with a first preferred aspect of the invention, there is provided a method for playing a game, the method comprising (a) providing a deck of playing tiles, each tile having a character printed on it; (b) determining the number of tiles as an initial hand for each player, the number of tiles comprising four, seven, ten or thirteen tiles; (c) providing each player with the initial hand of tiles; (d) during a turn for a player, requiring the player to draw one tile from the deck; and (e) playing the game until a player forms a winning hand, wherein the winning hand comprises two identical tiles, and the remaining tiles forming sets of three tiles selected from the group comprising: (i) a set of three identical tiles or (ii) a set of three sequential tiles in a suit.

Every player in the game draws a tile in step (d) at the same time.

During the same turn in step (d), further requiring the player to discard one of the tiles in the player's hand onto a discard pile if the player's hand does not form a winning hand.

Each player is provided with an initial hand of four tiles. The player wins by forming a winning hand with a fifth drawn tile. In this example, the winning hand will comprise two identical tiles, and the remaining three tiles selected from the group comprising: (i) a set of three identical tiles or (ii) a set of three sequential tiles in a suit.

Advantageously, game-play is not time-consuming since only five tiles are played by each player in the game. The present game also allows for more excitement since, as will be described in detail below, poker options (such as calling, raising and folding) are also available to each player. On average, it may take about three minutes for each round to complete. By “round”, it is meant to refer to a complete cycle where every player in the game has completed his action of drawing and discarding of the tiles. As an example, the game can move in either clockwise or counterclockwise direction. By “game”, it is meant to refer to the complete cycle from start of the game to when the game ends with the winner forming or obtaining a winning hand. It also includes the scenario where there is a tie which may occur in a situation where all the tiles from the deck are drawn and no winner has emerged with a winning hand.

Or as an alternative, each player is provided with an initial hand of seven tiles. In this example, the game is played until a player forms a winning hand with the eighth drawn tile. The winning hand comprises two identical tiles, and the remaining six tiles forms two sets of tiles, each set selected from the group comprising: (i) a set of three identical tiles or (ii) a set of three sequential tiles in a suit.

Or as an alternative, each player is provided with an initial hand of ten tiles. In this example, the game is played until a player forms a winning hand with the eleventh drawn tile. The winning hand comprises two identical tiles, and the remaining nine tiles forms three sets of tiles, each set selected from the group comprising: (i) a set of three identical tiles or (ii) a set of three sequential tiles in a suit.

Or as an alternative, each player is provided with an initial hand of thirteen tiles. In this example, the game is played until a player forms a winning hand with the fourteenth drawn tile. The winning hand comprises two identical tiles, and the remaining twelve tiles forms four sets of tiles, each set selected from the group comprising: (i) a set of three identical tiles or (ii) a set of three sequential tiles in a suit.

By “tiles”, it is meant to include any device that may be made of paper, plastic or the like, having on tile distinguishing characters printed on each of them. An example would be a pack of playing cards. It also includes any virtual device that may be played in an online game environment.

The set of playing tiles is a Mahjong set. An example would be those tiles used to play a conventional Chinese Mahjong. It may also include any cards that are printed with symbols associated with the conventional Chinese Mahjong.

The suit is selected from any one of the following Mahjong tile suits: Circle, Bamboo, Wan, East, South, West, North, Red Dragon, Green Dragon, White Dragon or Joker.

The method further comprises providing an initial wager at the start of the game. More preferably, the amount of the initial wager is determined at the start of the game and is provided by each player.

Each player has an option of calling, checking, raising, folding or following during the player's turn. More preferably, the option of calling, checking, raising, folding or following is made available to a player after requiring the player to draw one tile from the deck. Alternatively, the option of calling, checking, raising, folding or following is made available to a player after each player is provided with the initial hand of tiles and prior to requiring the player to draw an additional one tile from the deck.

The option of calling, checking, raising, folding or following may be made available only after the first round of play. However, the present invention may also allow for the options to be available to a player from the first round of play.

The terms “calling”, “checking”, “raising”, “folding” and “following” are those terms used in a poker game as known to the skilled person.

Advantageously, the present invention provides an option to players to increase the stakes of the game and chances of increases winnings.

The call amount is predetermined at the start of the game.

The game comprises a jackpot wherein the jackpot is given to player having a winning hand selected from the group comprising: Pure Character, One Nine Combination, Flush, Divine Hand or 4 Card or Earth Hand. Examples of these are provided and described below.

The method further comprises generating a random number to determine which player starts the game first. Preferably, the random number includes rolling at least one die. More than one die may be used depending on the number of players in the game. In fact it is possible that the game may use three or four dice.

Minimum number of players is at least two and the maximum number of players in a game is ten in one table. The game can be played in a plurality of tables as in a tournament. All tables may have an associated computer dealing with the administration of the game or the tournament.

Advantageously, the present invention allows for more players to play the game but also allows for the game to be played between 2 players.

In accordance with a second preferred aspect of the invention, there is provided a kit of parts comprising a deck of tiles and instructions for playing the game in accordance with the first aspect of the invention, the deck of tiles is a set of Mahjong tiles.

In accordance with a third preferred aspect of the invention, there is provided a method for playing a game method for operating an online gaming environment, the method comprising (a) hosting a game for at least two players, the game being conducted within the online gaming environment; and (b) conducting the game in accordance with the first aspect of the invention.

In accordance to the fourth preferred aspect of the invention, the game may also be played at a table or a plurality of tables with a kit of parts comprising a deck of tiles and instructions for playing the game in accordance with the first aspect of the invention in different venues including but not limited to at home, casinos and other venues.

In accordance to the fifth preferred aspect of the invention, the game may also be played in accordance with the first and third aspect of the invention through the internet including social network platforms that may be accessed via the internet or other communication networks with third parties

In accordance to the sixth preferred aspect of the invention, the game may also be played in accordance with the first and third aspect of the invention on information storage devices including but not limited to the CDs (C-ROMs), video compact disc (video discs), interactive CDs (CD-Is), on stand-alone machines similar to slot machines and on wireless devices including but not limited to mobile phones.

### BRIEF DESCRIPTION OF FIGURES

In order that the present invention may be fully understood and readily put into practical effect, there shall now be described by way of non-limitative examples only preferred embodiments of the present invention, the description being with reference to the accompanying illustrative figures.

In the Figures:

FIG. 1 shows conventional Mahjong tiles;

FIGS. 2A and 2B show an example of a player's hand according to an embodiment of the invention;

FIG. 3 shows examples of a “Pair”, a “Run” and a “Three-of-A-Kind” according to an embodiment of the invention;

FIG. 4 shows a screenshot of an online gaming environment according to an embodiment of the invention;

FIG. 5 shows examples of a “Pure Character”, a “One Nine Combination” and a “Flush” according to an embodiment of the invention; and

FIG. 6 shows a screenshot of a table providing gaming and scoring information in the online gaming environment according to an embodiment of the invention.

### DETAILED DESCRIPTION OF THE PREFERRED EMBODIMENTS

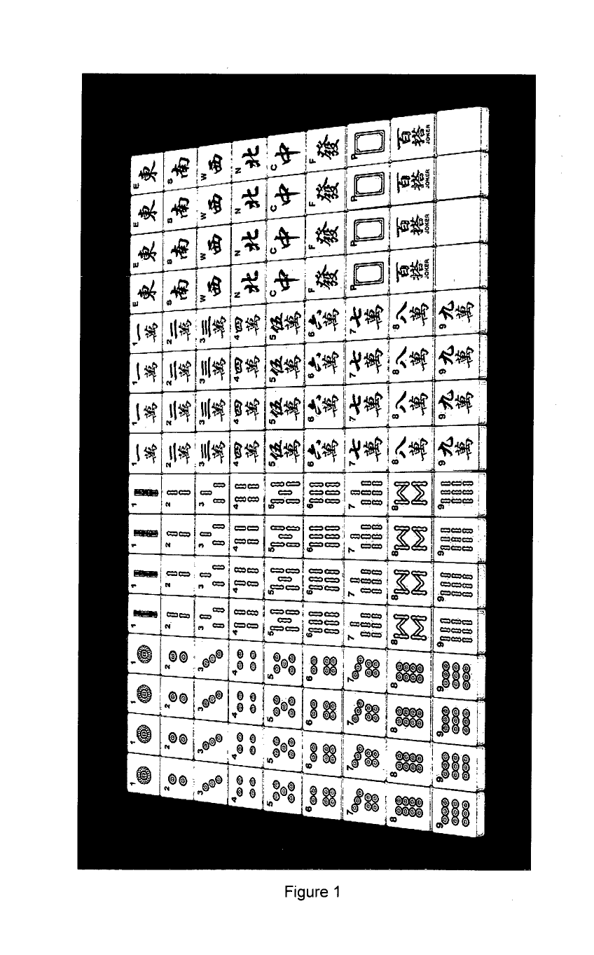

FIG. 1 shows Mahjong tiles used to play conventional Chinese Mahjong. The present invention adopts the use of these conventional tiles. In a preferred embodiment, the present invention is played on a total of 140 tiles. The following is a breakdown of these tiles (suits) used in an exemplary embodiment of the invention:

General Tiles
36 circle suit (4 sets of 1-9 circle tiles)
36 bamboo suit (4 sets of 1-9 bamboo tiles)
36 “wan” suit (4 sets of 1-9 “wan” tiles)

Character Tiles
East suit (4 east tiles)
South suit (4 south tiles)
West suit (4 west tiles)
North suit (4 north tiles)
Red Dragon suit (4 red dragon tiles)
Green Dragon suit (4 green dragon tiles)
White dragon suit (4 white dragon tiles)

Special Tiles
4 jokers (these joker tiles may be used to represent any tile)

In alternative examples of the invention, there may be any number of Jokers used to play the game. In a preferred embodiment of the present invention, the “Flowers” and “Seasons” suits may not be used.

The game allows for a minimum of 2 to a maximum of 10 players at the same time. The method comprising providing a deck of playing tiles wherein each tile has a character printed on it. The playing tiles may include any such pack of tiles or cards that may be include sequential characters grouped in suits and differentiated from one another. Playing cards may be used, but in the present invention, a set of Mahjong tiles may be used. The number of tiles for each player as an initial hand is first determined at the start of the game. At the start of the game, each player will then be provided with the determined 4, 7, 10 or 13 tiles.

The game may be played with an initial hand of 4, 7, 10 or 13 tiles. For each initial hand, this means that each player will have to form a winning hand with an additional 5^{th}, 8^{th}, 11^{th} or 14^{th} tile respectively.

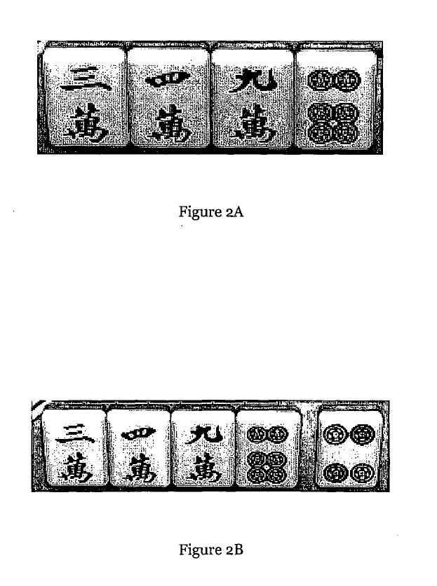

For example, in the case of a game having an initial hand of 4 tiles, a player has to win by drawing an additional 5^{th} tile. FIGS. 2A and 2B show such an example. As shown in the Figures, at the start of the game, a player starts with 4 tiles as shown in FIG. 2A. The 4 tiles shown in FIG. 2A are examples of what may be drawn from the deck of tiles. The player is then required to draw a 5^{th} tile (as shown in FIG. 2B) from the deck. With the 5^{th} tile, the player can form a winning hand in order to win the game. Otherwise, the player will then have to discard 1 of the 5 tiles. The game continues until a player forms a winning hand. The game is described in detail below, but in this example, a winning hand comprises two identical tiles, and the remaining three tiles (of the 5 tiles) selected from the group comprising: (i) a set of three identical tiles or (ii) a set of three sequential tiles in a suit.

With each player having an initial hand of 4 tiles each, the game starts with a first player drawing 1 tile from the deck. This will be the player's 5^{th} tile including the earlier 4 tiles that were provided earlier at the start of the game. In the same turn, unless the player has a winning hand, the player will then have to discard 1 of the 5 tiles in the player's hand onto a discard pile in order to complete a turn in the round. The discarded tiles may not be reused by other players in the game.

In an alternative embodiment, in the event where the initial hand is 4 tiles, every player in the game draws (or is given) the additional 5^{th} tile at the same time. Similarly, if the initial hand is 7, 10, or 13 tiles, then every player is given the addition of 8^{th}, 11^{th} or 14^{th} tile respectively at the same time. Similar to the game of poker, each player will then be provided with the options of checking, calling, raising, folding or following. After each player has been given a chance to bet at the same amount (i.e. there is no further raising), the game continues with a player discarding one of the 5 (8, 11 or 14 as the case may be) tiles in his hand and drawing a further tile from the deck. Again, the game continues until a player forms a winning hand.

Moving in a counter or counterclockwise direction, the drawing and discarding of the tiles continues until the last player has had a turn. In a preferred embodiment, a Joker tile cannot be discarded onto the discard pile. Alternatively, the Joker tile can be discarded if the player hopes to form a winning hand that qualifies for a jackpot. No additional ante may be required for the first round.

Before the start of the game, there is provided an initial wager. This initial wager may be provided by the host of the game or it may be provided by each player as agreed among the players.

From the second round onwards, each player has an option of calling, checking, following, raising or folding before the player takes the turn. Calling refers to a player's decision to place the same wager (or bet) amount as the player before him, or the same amount as the initial wager. Calling will entitle players to draw 1 additional tile and decide 1 out of their 5 tiles to be discarded. The initial call amount may be a fixed predetermined amount.

When checking, a player may decline to make a bet but retain the right to call or raise later in the round. This is available to the first player or the next player after the previous player who has made a checking.

Raising is defined as the action by a player to increase the wager amount. There may be no limit to the amount raised. However, all players can agree before the start of the game to set a limit to the amount of call and raise. After a player has decided to use the raise option, the call amount will increase accordingly. More than 1 player can raise in a single round as long as the conditions for raising are met. These conditions are the same as those used in a game of poker.

Players may also decide to fold and end the player's participation in the game. Thus, forfeiting any wager placed by that player earlier in the game.

In an example of the present game, calling, checking, following, raising or folding is available only after the first round of play. Alternatively, these options may be available to players from the first round of play. When these options are available to players, the first player can call or check. The next player can then fold, follow (which includes check) or raise.

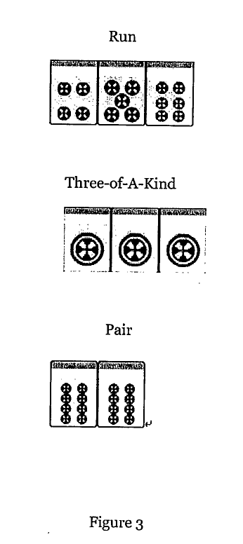

The game continues until a player forms the winning hand with the drawing of the 5^{th} tile. The winning hand comprises two identical tiles (which may also be known as a “Pair”), and the remaining tiles forming sets of three tiles selected from the group comprising: (i) a set of three identical tiles (which may also be known as a “Three-Of-A-Kind”) or (ii) a set of three sequential tiles in a suit (which may also be known as a “Run”). FIG. 3 shows examples of a “Pair”, a “Run” and a “Three-of-A-Kind”.

By “sequential”, it is meant to include the number sequence that runs in each suit (e.g. 1, 2, 3, 4, etc.). Therefore, by “sequence of three consecutive tiles”, it is meant to include any 3 tiles have the consecutive sequence (e.g. [1, 2 and 3] or [4, 5 and 6] etc.).

Alternatively, at the start of the game, each player is provided with an initial hand of 7 tiles. The method of playing the game is similar to that described above. Each player then draws an 8^{th} tile from the Mahjong tile set. The game is played until a player forms a winning hand with the 8^{th} drawn tile. In this example, the winning hand comprises two identical tiles of the same rank and suit, and the remaining six tiles forming two sets of tiles, each set selected from the group comprising: a sequence of three consecutive tiles of the same suit or three identical tiles of the same rank and suit.

In another alternative embodiment, each player is provided with an initial hand of ten tiles and the game is played as described above except that, in this example, a player forms a winning hand with the 11^{th} tile drawn. In this example, the winning hand comprises two identical tiles of the same rank and suit, and the remaining nine tiles forming three sets of tiles, each set selected from the group comprising: a sequence of three consecutive tiles of the same suit or three identical tiles of the same rank and suit.

The winner of the game will acquire the prize money which is equivalent to the total amount of wager provided by all the players during the course of the game. A draw condition is met when none of the players has a winning hand after all the tiles have been drawn from the deck. In such an event, the money will be returned to the respective players.

In an alternative embodiment, the game of the present invention may be played in an online gaming environment. The method for operating an online gaming environment comprises (a) hosting a game for at least two players, the game being conducted within the online gaming environment; and (b) conducting the game in accordance with the method described above.

In a still alternative embodiment, the present invention may be a kit of parts comprising a Mahjong set and a set of instructions for playing the game as described in this document.

The online gaming environment provides for players to log onto the system to play the game. The environment provides virtual game tables or rooms that can accommodate between 2 to 10 players. As described above, the minimum number of players to start a game is 2. Therefore, when a table has 2 or more players seated, a 10-second timer (or any amount of predetermined time) will start counting down.

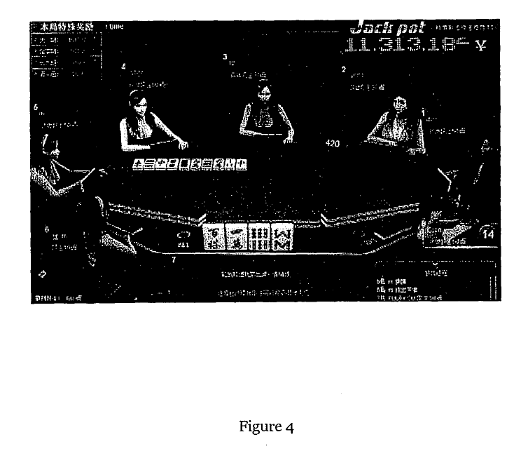

FIG. 4 shows an example of a screenshot of the online gaming environment.

The online gaming environment may be organised in a way that is known by a skilled person in the art. The environment may be wired or wireless and comprises a network server for communicating with devices (e.g. computers) used by players for playing the game, and a user interface at these devices. The network server may store players' personal account particulars such as user IDs and passwords, and also accept payment. Each player will have to log onto the system in order to play the game.

The system may allocate players to tables having available seats or the players themselves may select the tables at which they wish to play the game. Alternatively, the system will first assign players to tables having only 1 player, so that the game can start as long as there are 2 players. If there is no table with only 1 player, then players may randomly be assigned to any of the available tables.

Before a game begins, the system will randomly generate numbers in order to determine the first player of the game. This first player may also be known as the “dealer”. In a preferred embodiment, the system generates the random number by rolling 3 six-faced dice. The total number added up from the 3 dice represents the number of players counted from a player designated in position number 1. That player may also be designated as a “dealer”. This “dealer” will then start the game by first drawing 1 tile from the set of Mahjong tiles and game proceeds as described above. Alternatively, the “dealer” may not be a player of the game. In such a scenario, a blind may be used as an initial wager. A blind is a forced bet that is placed before a hand is dealt and may be small blind or big blind, that may be placed by two players to the right of the dealer in a clockwise or counterclockwise direction (or left of the dealer in a clockwise or counterclockwise direction). As mentioned above, the direction of play may be determined at the start of the game. Alternative to the above, the player after the big blind may start the game.

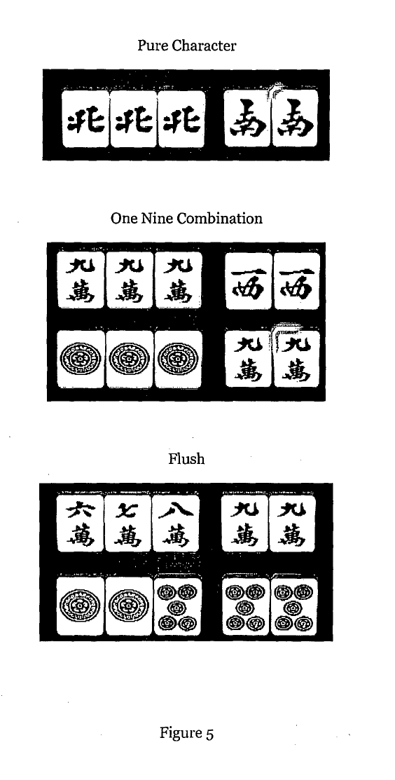

In addition to the total amount of wager a player may potentially win, a player may also win a Jackpot when the winning hand includes any one selected from the group: “Pure Character”, “One Nine Combination”, “Flush”, “Divine Hand”, “4 Card” or “Earth Hand”. FIG. 5 shows an example of each of these.

A “Pure Character” is defined when a winner's tiles comprises strictly east tile, south tile, west tile, north tile, red dragon, green dragon, white dragon. As shown in FIG. 5, an example of a “Pure Character” combination includes 3 north tiles+2 south tiles.

A “One Nine Combination” is defined when a winner's tiles comprises strictly one or nine (circle/bamboo/“wan”) or any Character tiles. As shown in FIG. 5, an example of a “One Nine Combination” includes 3 9-“wan” tiles+2 west tiles, or 3 1-circle tiles+2 9-“wan” tiles.

A “Flush” is defined when all 5 of a winner's tiles are of the same suite (circle, bamboo or “wan”).

A “Divine Hand” is defined when the first player, or “dealer”, of the game (during the first round of the game) forms a winning hand after drawing the 5^{th} tile.

A “4 Card” is defined when a player has 4 identical cards.

A “Earth Hand” is defined when a player other than the “dealer” forms a winning hand in the first round of the game.

If more than one player has the Jackpot winning hand at the same time, the Jackpot is shared equally among these players.

In addition to the Jackpot, there may be pot(s) of money available to players to win. There may be at least one pot of money available to the players to win in each round wherein each pot comprises of money contributed by each player. Play of the game is as described above. In each round of betting, it starts with the first player and continues either clockwise or counter-clockwise as agreed by all players at the beginning of the game until all remaining players have put into a pot the same amount of money.

In an example, in round 1 of the game, each player may contribute a predetermined amount of money to a pot, e.g. “Pot 1”. In round 2, another “Pot 2” is set up to similarly contain contributions from each player. A player can choose to contribute to the pot. Usually, the second “Pot 2” is set up because a player has insufficient funds to contribute to the previous pot. Similarly, “Pot 3” may be set up in round 3. This may continue until a player wins the game. However, the winning player may only win the pot(s) of money if he has contributed money to that pot(s).

Below is an example of how the pot money is contributed and won:

Given 3 players—Player 1, Player 2 & Player 3

Player 1 has $200

Player 2 has $2000

Player 3 has $3000

It is determined that each player contributes $200 each in a pot. Therefore, “Pot 1” has $600 and it comprises $200 from each player. Now, each player has the following amount:

Player 1 has $0

Player 2 has $1800

Player 3 has $2800

Player 1 now has no more money to contribute to the pot. Hence, “Pot 2” is set up to receive contributions from Players 2 and 3 only. The amount in “Pot 2” may be predetermined. Alternatively, in the event where a player does not have sufficient funds to match the bets placed by the preceding player, then another pot of money may be formed which consists of betting contributions from the other players

If Player 1 wins, he only wins “Pot 1” and the game continues until there is a winner for “Pot 2”. If Player 2 wins, then he will win “Pot 1” (assuming no one has yet won “Pot 1”) and “Pot 2”. When all the tiles from the deck are drawn and there is no player with a winning hand, the game is considered a draw and the money in the pot(s) is returned to each player in accordance with the amount he has contributed to the pot(s).

If all other players have left the game, the last player who still stayed in the game will win without a winning hand. Or, during the game, if any player get disconnected or takes longer than a predetermined time period to take the turn, that player's default action will be considered as fold.

In an example of the invention, the game starts with each player having 4, 7, 10, or 13 tiles in an initial hand as the case may be. For simplicity, the game will be described with each player having an initial hand of 4 tiles. Once each player has been provided with the initial hand, the betting (the options of checking, folding, following, calling or raising being similar to the game of poker and as described above) starts after each player has had the opportunity to draw the 5^{th} tile. Likewise, for the initial hand of 7, 10 or 13 tiles where the betting starts when each player has had the opportunity to draw the 8^{th}, 11^{th} or 14^{th} tile respectively. After the first round of betting, a player with a winning hand takes all the money in the pot. When a player wins, the other players in the game may be required to show all the tiles in their hand. This may be known as “show hand”. If there are more than 1 player with a winning hand in that round, the money is then shared or distributed equally among those players. If no player has a winning hand in that round, then the game continues with a second round of betting. The method of play is as described above, i.e. the first player in the round will discard one tile and then draw a new tile from the deck. However, in an exemplary embodiment, the betting (the options of checking, folding, following, calling or raising) starts again after each player has discarded and drawn the new tile from the deck in the second round. Once again, the play continues and if a player in this second round has a winning hand, that player will win the pot of money. If there is no winning hand in the second round, then the game continues into a third round and so on. Play is repeated as described in this paragraph. In the event of a draw where no player forms a winning hand after all the tiles are drawn from the deck, the money in the pot or pots is returned to each player.

In an alternative example of the invention, each player is first provided with an initial hand (of 4, 7, 10 or 13 tiles as the case may be). For simplicity, the game will be described with each player having an initial hand of 4 tiles. However, betting occurs before the players draw the 5^{th} additional tile. This means that before the players draw the additional tile from the deck, each player will take turns to place bets (i.e. checking, folding, following, calling or raising being similar to the game of poker and as described above). The wagers arising from the betting process may form a money pot. Once the betting process has been completed, the players will then draw the additional tile (5^{th} tile in the case where the initial hand comprises 4 tiles, 8^{th} tile in the case where the initial hand comprises 7 tiles, 11^{th} tile in the case where the initial hand comprises 10 tiles and 14^{th} tiles in the case where the initial hand comprises of 13 tiles). The player with a winning hand will win the money in the money pot. When a player wins, the other players in the game may be required to show all the tiles in their hand. This may be known as “show hand”. If there are more than 1 player with a winning hand in that round, the money in the money pot is then shared or distributed equally among those players. If no player has a winning hand in that round, then the game continues and each player will have to discard a tile in his hand onto a discard pile. The method of play is then repeated, i.e. each player take turns to place bets before drawing the additional tile and so on.

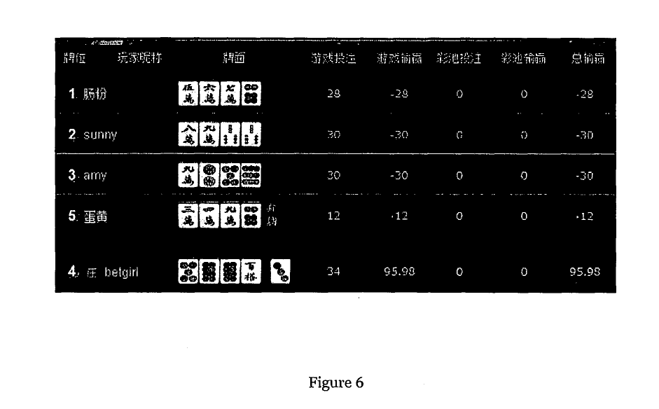

FIG. 6 shows a screenshot of the game and scoring information. Information such as a player's amount of bet, amount of loses and number of wins may be recorded and shown.

Whilst there has been described in the foregoing description preferred embodiments of the present invention, it will be understood by those skilled in the technology concerned that many variations or modifications in details of design or construction may be made without departing from the present invention. In particular, the above method of playing the game may vary when the game is played with a “dealer” who can set house rules before the game starts.

1. A method for playing a game, the method comprising:
(a) providing a deck of playing tiles, each tile having a character printed on it;
(b) determining the number of tiles as an initial hand for each player, the number of tiles comprising four, seven, ten or thirteen tiles;
(c) providing each player with the initial hand of tiles;
(d) during a turn for a player, requiring the player to draw one tile from the deck; and
(e) playing the game until a player forms a winning hand,
wherein the winning hand comprises two identical tiles, and the remaining tiles forming sets of three tiles selected from the group comprising: (i) a set of three identical tiles or (ii) a set of three sequential tiles in a suit.

2. The method according to claim 1, wherein every player in the game draws a tile in step (d) at the same time.

3. The method according to claim 1, wherein during the same turn in step (d), further requiring the player to discard one of the tiles in the player's hand onto a discard pile if the player's hand does not form a winning hand.

4. The method according to claim 1, wherein each player is provided with an initial hand of four tiles.

5. The method according to claim 1, wherein each player is provided with an initial hand of seven tiles.

6. The method according to claim 1, wherein each player is provided with an initial hand of ten tiles.

7. The method according to claim 1, wherein each player is provided with an initial hand of thirteen tiles.

8. The method according to claim 1, wherein the set of playing tiles is a Mahjong set.

9. The method according to claim 8, wherein the suit is selected from any one of the following Mahjong tile suits: Circle, Bamboo, Wan, East, South, West, North, Red 5 Dragon, Green Dragon, White Dragon or Joker.

10. The method according to claim 1, the method further comprising providing an initial wager at the start of the game.

11. The method according to claim 8, wherein the amount of the initial wager is determined at the start of the game and is provided by each player.

12. The method according to claim 1, wherein each player has an option of calling, checking, raising, folding or following during the player's turn.

13. The method according to claim 12, wherein the option of calling, checking, raising, folding or following is made available to a player after requiring the player to draw one tile from the deck.

14. The method according to claim 12, wherein the option of calling, checking, raising, folding or following is made available to a player after each player is provided with the initial hand of tiles and prior to requiring the player to draw an additional one tile from the deck.

15. The method according to claim 12, wherein the option of calling, checking, raising, folding or following is available after the first round of play.

16. The method according to claim 12, wherein the call amount is predetermined at the start of the game.

17. The method according to claim 1, further comprising a jackpot wherein the jackpot is given to the player having a winning hand selected from the group comprising: Pure Character, One Nine Combination, Flush, Divine Hand or 4 Card or Earth Hand.

18. The method according to claim 1, further comprising generating a random number to determine which player starts the game first.

19. The method according to claim 18, wherein generating the random number includes rolling at least one die.

20. The method according to claim 1, wherein the number of players is at least two.

21. The method according to claim 1, wherein the maximum number of players in a game is ten.

22. A kit of parts comprising a deck of tiles and instructions for playing a game according to claim 1.

23. The kit of parts according to claim 22 wherein the deck of tiles is a set of Mahjong tiles.

24. A method for operating an online gaming environment, the method comprising:
(a) hosting a game for at least two players, the game being conducted within the online gaming environment; and
(b) conducting the game in accordance with the method according to claim 1.

25. A method for conducting the game in accordance with claim 1 at a table or a plurality of tables as in a tournament in different venues including but not limited to home, casinos and other venues.

26. A method of conducting the online game in accordance with claim 1 through the internet including social network platforms that may be accessed via the internet or other communication networks with third parties

27. A method of conducting the online game in accordance with claim 1 on information storage devices including but not limited to the CDs (C-ROMs), video compact disc (video discs), interactive CDs (CD-Is), on stand-alone machines similar to slot machines and on wireless devices including but not limited to mobile phones.
